(19) United States
(12) Patent Application Publication
(10) Pub. No.: US 2022/0038778 A1
(43) Pub. Date: Feb. 3, 2022

(54) INTELLIGENT CAPTIONING

(71) Applicant: Microsoft Technology Licensing, LLC, Redmond, WA (US)

(72) Inventor: Fehmi CHEBIL, San Jose, CA (US)

(21) Appl. No.: 16/941,198

(22) Filed: Jul. 28, 2020

(51) Int. Cl. H04N 21/466; H04N 21/462

(52) U.S. Cl. CPC H04N 21/466; H04N 21/462

(57) ABSTRACT

The present disclosure relates to systems, methods, and computer-readable media for intelligent captioning. The systems and methods may turn on captioning based on the content or the user and may turn off captioning when conditions for showing the captioning are not present. The systems and methods may learn the user habit information for captioning based on user interactions with the content. The systems and methods may generate captioning recommendations for turning captioning on or turning captioning off based on the user habit information. The captioning recommendation may be sent to one or more content providers. The content providers may use the captioning recommendations to intelligently switch the captioning on and the captioning off based on the captioning recommendations.

### BACKGROUND

Watching content provided by media content providers, there is the option to either select captioning of content or not to select captioning of content. Thus, the captioning either exists or does not exists. Having the captioning turned on allows the user to understand all the audio and the user may not miss any part of the audio. However, having the captioning turned on may come at disadvantages to the user experience with the content.

As such, there is a need in the art for improvements in providing captioning with content.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a method. The method may include receiving at least one user input for content selected by the user to view on a user device. The method may include receiving content information for a time period associated with the at least one user input. The method may include receiving context information associated with the content or the user. The method may include learning user habit information by analyzing the content information, the at least one user input, and the context information to determine the user habit information for the time period. The method may include generating a captioning recommendation for the content based on the user habit information. The method may include transmitting the captioning recommendation for the content.

Another example implementation relates to a computer device. The computer device may include a memory to store data and instructions; and at least one processor operable to communicate with the memory, wherein the at least one processor is operable to: receive at least one user input for content selected by the user to view on a user device; receive content information for a time period associated with the at least one user input; receive context information associated with the content or the user; learn user habit information by analyzing the content information, the at least one user input, and the context information to determine the user habit information for the time period; generate a captioning recommendation based on the user habit information; and transmit the captioning recommendation for the content.

Another example implementation relates to a method. The method may include receiving a content request for content. The method may include receiving a captioning recommendation for turning on captioning or turning off captioning for the content. The method may include making a captioning decision to turn captions on or turn the captions off for the content based on the captioning recommendation. The method may include dynamically updating the captions for the content in response to the captioning decision.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for use with providing intelligent captioning in accordance with an implementation of the present disclosure.

FIG. 2 illustrates an example data structure for use with a content interaction analysis system in accordance with an implementation of the present disclosure.

FIG. 3 illustrates an example timeline of dynamically updating the captions in accordance with an implementation of the present disclosure.

FIG. 4 illustrates an example method for transmitting user information in accordance with an implementation of the present disclosure.

FIG. 5 illustrates an example method for generating a captioning recommendation in accordance with an implementation of the present disclosure.

FIG. 6 illustrates an example method for dynamically updating captions in accordance with an implementation of the present disclosure.

FIG. 7 illustrates certain components that may be included within a computer system.

### DETAILED DESCRIPTION

This disclosure generally relates to captioning provided with content. Watching content from any content provider, such as, but not limited to, a movie or a television show, a user may either select to have the captioning turned on or select to have the captioning turned off. Having the captioning turned on allows captions with text of the audio from the content to display along with the content. As such, the user may not miss any part of the content and may understand all the audio being outputted from the content. However, having the captioning turned on may come at a disadvantage to the user.

The captioning may block or otherwise obstruct a portion of the content displayed as sometimes the captioning overwrites other information on the content. For example, when someone speaks in a documentary, the identity of the speaker may be hidden by the captioning. The user may need to stop the content, turn off the captioning, and rewind for a few seconds to see what the user missed by having the captioning turned on. In addition, the captioning may be out of synch with the content and may provide information that has not been spoken in the content, which may result in a poor user experience by spoiling events in the content before they occur. The captioning may also involuntary make the users read the text, resulting in the users missing what is going on in the scene.

On the other hand, captioning is very important for aiding users in understanding all the audio of the content. Captioning may provide a transcript or translation of the dialogue, sound effects, relevant musical cues, and/or other relevant audio information when sound is unavailable or not clearly audible. For example, when the audio is low or may be difficult to understand by a user, captioning may help users understand the audio. In addition, the user may be hearing impaired and may need captioning to help understand the audio. Moreover, the audio may be in a different language and captioning may help users understand the audio. Captioning may also display captions with text from the transcript on a display as the audio occurs.

The devices and methods provide intelligent captioning based on the content and/or the user. The devices and methods may turn on captioning based on the content and/or the user and may turn off captioning when conditions for showing the captioning are not present. This disclosure includes several practical applications that provide benefits and/or solve problems associated with improving captioning.

The devices and methods may turn on and/or turn off the captioning based on the content. For example, when the audio may not be clear, such as, but not limited to, someone speaking on the telephone, a low peak signal to noise ratio (e.g., background noise) in the audio, someone with a heavy accent, and/or someone speaking in another language, the captioning may be turned on.

The devices and methods may also turn on and/or turn off the captioning based on the user. For example, the user may be a non-native speaker having difficulty capturing what was said from a character in a movie, so when that character speaks the captioning may appear. However, if someone else is speaking clearly, the viewer may not need the captioning, and the captioning may be turned off.

The devices and methods may include a content interaction analysis system that learns the user habits and/or needs for captioning based on user interactions with the content. The content interaction system may be a machine learning system that receives one or more of content information, context information, and/or user inputs identifying user interactions with the content during specific time periods. The machine learning system may use the information received to continuously learn the habits of the users for captioning and may generate captioning recommendations for turning captioning on or turning captioning off based on the user habit information. The captioning recommendation may be sent to one or more content providers. The content providers may use the captioning recommendations to intelligently switch the captioning on and the captioning off based on the captioning recommendations.

As the content interaction analysis system learns the habits of the users, the content providers may tailor the captioning for the user by dynamically turning the captions on or turning the captions off based on the captioning recommendations. The user experience with content may be improved by having the captions turned on when the user may need captioning and turning the captions off when the user may not need captioning. Thus, by tailoring the captions to the habits and interactions of the user, the user may receive the benefits of captioning when needed without having to specifically request captioning.

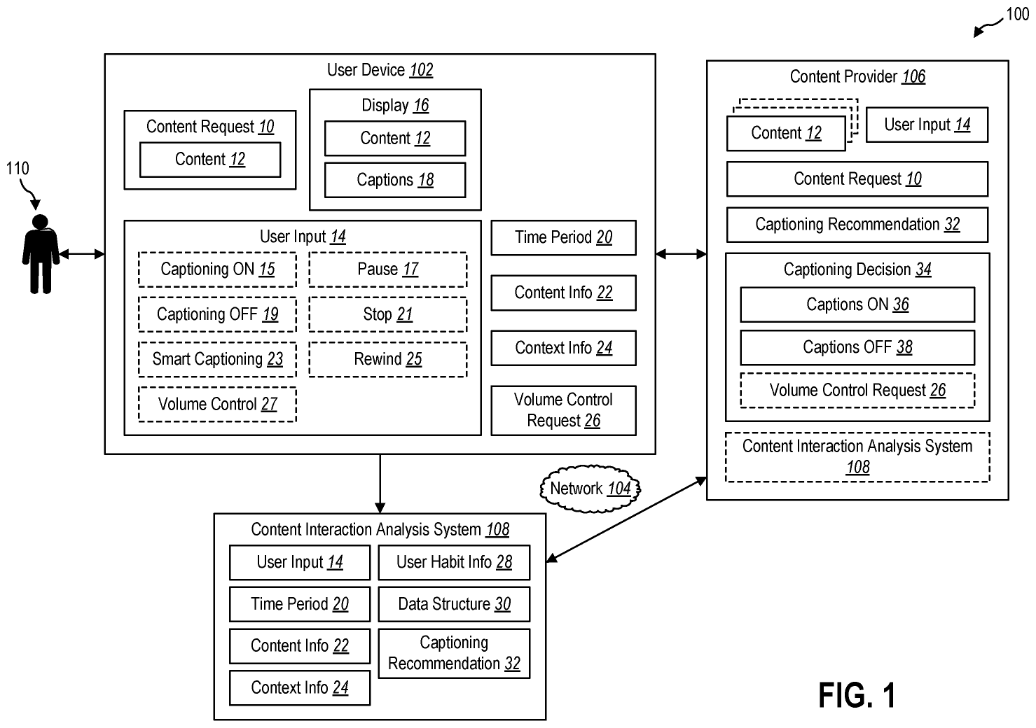

Referring now to FIG. 1, an example environment 100 for use with providing intelligent or smart captioning may include a user device 102 that a user 110 may use to view content 12 received or accessed from one or more content providers 106. User device 102 may be in communication with one or more content providers 106 and/or one or more content interaction analysis systems 108 that may be used to learn user habit information 38 to for user 110. The user habit information 38 may be used to learn any captioning needs that user 110 may require.

User device 102 may receive one or more content requests 10 from user 110 for content 12 to view on a display 16. User device 102 may be communicatively coupled (e.g., wired or wirelessly) to a display 16 having a graphical user interface thereon for providing a display of content 12. User device 102 may transmit the content requests 10 to one or more content providers 106.

Content providers 106 may host a plurality of content 12 and may receive the content request 10 for content 12. Content provider 106 may provide the requested content 12 to user device 102. For example, content provider 106 may transmit content 12 to user device 102. In addition, content provider 106 may provide direct access to the content 12 by user device 102 (e.g., streaming content 12 directly by user device 102). Content provider 106 may turn captions on 36 or turn captions off 38 when providing content 12 to user device 102 in response to receiving user input 14 regarding the captioning. Thus, if user 110 selects to have captioning on 15, content provider 106 may turn captions on 36 and display 16 may present captions 18 along with content 12. If user 110, selects to have captioning off 19, content provider 106 may turn captions off 38 and display 16 may present content 12 without captions 18.

While a single user device 102 is illustrated, environment 100 may include a plurality of user devices 102 in communication with one or more content providers 106 and/or one or more content interaction analysis systems 108 via a network 104. Moreover, while a single content interaction analysis system 108 is illustrated, environment 100 may include a plurality of content interaction analysis systems 108 interacting with one or more content providers 106. In addition, while content interaction analysis system 108 is illustrated remote from content provider 106, content interaction analysis system 108 may be included in content provider 106.

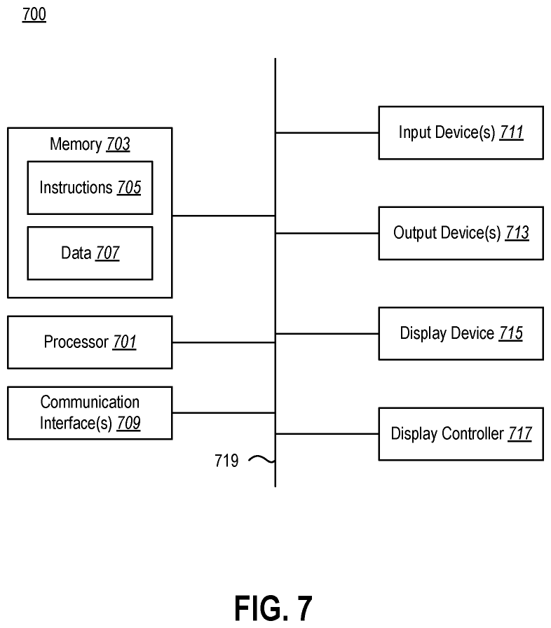

User device 102 may include any mobile or fixed computer device, which may be connectable to a network. User device 102 may include, for example, a mobile device, such as, a mobile telephone, a smart phone, a personal digital assistant (PDA), a tablet, or a laptop. Additionally, or alternatively, user device 102 may include one or more non-mobile devices such as a desktop computer, server device, or other non-portable devices. Additionally, or alternatively, user device 102 may include a gaming device, a mixed reality or virtual reality device, a music device, a television, a navigation system, or a camera, or any other device having wired and/or wireless connection capability with one or more other devices. User device 102, content provider 106, and/or content interaction analysis system 108 may include features and functionality described below in connection with FIG. 7.

In addition, the components of content interaction analysis system 108 and/or content provider 106 may include hardware, software, or both. For example, the components of content interaction analysis system 108 and/or content provider 106 may include one or more instructions stored on a computer-readable storage medium and executable by processors of one or more computing devices. When executed by the one or more processors, the computer-executable instructions of one or more computing devices (e.g., content interaction analysis system 108 and/or content provider 106) can perform one or more methods described herein. Alternatively, the components of content interaction analysis system 108 and/or content provider 106 may include hardware, such as a special purpose processing device to perform a certain function or group of functions. Additionally, or alternatively, the components of content interaction analysis system 108 and/or content provider 106 may include a combination of computer-executable instructions and hardware.

Display 16 may present content 12 and/or any captions 18 received from content provider 106. User device 102 may receive one or more user inputs 14 to control a display of the content 12. For example, user 110 may pause 17 content 12, stop 21 content 12, and/or rewind 25 content 12.

User device 102 may also receive user input 14 indicating a captioning preference for user 110. For example, user 110 may select captioning on 15 (e.g., displaying captions 18 with content 12), captioning off 19 (displaying content 12 without captions 18), or smart captioning 23. Smart captioning 23 may dynamically update displaying captions 18 with content 12 and may turn off captions 18 from displaying with content 12 based on the content 12 and/or user 110. Thus, instead of user 110 specifying whether to turn captioning on 15 or turn captioning off 19, smart captioning 23 may automatically turn captioning on or turn the captioning off based on learned user habits information associated with captioning.

When user 110 provides one or more user inputs 14, user device 102 may determine a time period 20 associated with the one or more user inputs 14. Time period 20 may start upon user device 102 receiving user input 14 and may end upon completion of an action associated with user input 14. In addition, time period 20 may end upon user device 102 receiving a different user input 14. For example, time period 20 may identify an amount of time a user rewound content 12 or paused content 12. Another example of time period 20 may include an amount of time user 110 selected captioning on 15. Yet another example of time period 20 may include an amount of time user 110 selected captioning off 19.

User device 102 may automatically extract content information 22 from content 12 associated with time period 20. Content information 22 may include, but is not limited to, a genre (e.g., comedy, action, or crime), a content type (e.g., movie, television show, documentary), volume of the audio output by user device 102, identifying actors present during time period 20, languages spoken during time period 20, and/or any other information that may be extracted from content 12 by user device 102. User device 102 may extract different content information 22 for different time periods 20. Thus, as the time period 20 changes, the content information 22 may also change and user device 102 may update the extracted content information 22 and/or extract different content information 22.

In addition, user device 102 may automatically identify any context information 24 associated with user 110 during time period 20. Context information may include, but is not limited to, date information, time information (e.g., nighttime, early morning, middle of the day), geographic location information (e.g., moving vehicle, home, or work), environment information (e.g., inside, outside, or current weather), and/or any additional information that may describe an environment of user 110. As time period 20 changes, the context information 24 associated with user 110 may change, and user device 102 may update and/or modify the identified context information 24 for user 110.

In an implementation, user device 102 may automatically transmit the user input 14, time period 20, content information 22, and/or any context information 24 to content interaction analysis system 108. In another implementation, user device 102 may transmit user input 14, time period 20, content information 22, and/or any context information 24 to content interaction analysis system 108 in response to one or more triggering events. Triggering events may include, but are not limited to, content 12 ending or stopping, user 110 selecting captioning on 15, user 110 selecting captioning off 19, user 110 selecting smart captioning 23, user 110 selecting to pause the content 12, user 110 selecting to stop 21 the content 12, user 110 selecting to rewind 25 the content 12, and/or user 110 providing a volume control 27 (e.g., mute, lowering the volume, or raising the volume).

In another implementation, user device 102 may periodically transmit the user inputs 14, time periods 20, content information 22, and/or any context information 24 to content interaction analysis system 108. As such, user device 102 may aggregate the user inputs 14, time periods 20, content information 22, and/or any context information 24 and may transmit the information at set time periods (e.g., every 10 minutes).

Content interaction analysis system 108 may receive the user input 14, time period 20, content information 22, and/or context information 24 from one or more user devices 102. Content interaction analysis system 108 may analyze the received information to learn user habit information 28 for user 110 and/or any captioning needs for user 110.

Content interaction analysis system 108 may use the time period 20 to identify one or more factors in content 12, content information 22, and/or context information 24 that may have triggered a need for request for captioning. One or more factors may include, but are not limited to, a high signal to noise ratio in content 12, individuals speaking a foreign language in content 12, a time of day (e.g., nighttime), a volume level of user device 102 (e.g., a low volume or mute) when playing content 12, individuals speaking foul language in content 12, a particular actor or individual speaking in content 12, rewinding content 12, pausing content 12, and/or stopping content 12.

Content interaction analysis system 108 may correlate, or otherwise associate, interactions user 110 took relative to the one or more potential factors that may trigger a need for captioning. In addition, content interaction analysis system 108 may correlate, or otherwise associate, interactions user 110 took relative to turning off captioning. Content interaction analysis system 108 may use this correlation or association to learn user habit information 28 for user 110 for turning on captioning, turning off captioning, pausing content 12, stopping content 12, and/or rewinding content 12.

One example use case may include content interaction analysis system 108 analyzing content 12 during time period 20 to determine whether there is high signal to noise ratio in content 12 (e.g., background noise) making it difficult to hear audio in content 12 during time period 20. For example, a party may be occurring in a scene in content 12 during time period 20 with multiple individuals speaking at once. Content interaction analysis system 108 may identify the user input 14 associated with the party. If user 110 selected captioning on 15 during the party, content interaction analysis system 108 may learn that user 110 has difficulty understanding the audio of content 12 when a party is occurring in content 12. Another example may include traffic going by while an individual is speaking during time period 20. Content interaction analysis system 108 may identify the user input 14 associated with the traffic. If user 110 selected to repeatedly rewind 25 content 12 while the traffic was in the scene, content interaction analysis system 108 may learn that user 110 has difficulty understanding the audio of content 12 when individuals are speaking with traffic in the background. Another example may include a storm occurring in a scene while an individual is speaking during time period 20. Content interaction analysis system 108 may identify the user input 14 associated with the storm. If user 110 selected to repeatedly stop 21 content 12 while the storm was occurring, content interaction analysis system 108 may learn that user 110 has difficulty understanding the audio of content 12 when individuals are speaking with a storm in the background of the scene.

Another use case may include content interaction analysis system 108 analyzing content 12 during time period 20 to identify which individuals may be speaking. Content interaction analysis system 108 may identity actors or individuals that user 110 has difficulty understanding based on the analysis. The actors or individuals may have an accent that may be difficult for user 110 to understand, and/or the actors or individuals may speak in a lower voice that may be difficult for user 110 to understand. For example, if user 110 consistently rewinds 25 or pauses 17 content 12 when the same individual is speaking, content interaction analysis system 108 may determine that user 110 has difficulty understanding that individual. Another example may include actors or individuals speaking on a telephone during a scene in time period 20 where a portion of the dialogue may be muted or lower. Content interaction analysis system 108 may identify the user input 14 associated with the telephone call. If user 110 repeatedly pauses 17 content 12 during the telephone call, content interaction analysis system 108 may learn that user 110 has difficulty understanding when actors or individuals are speaking on a telephone call in a scene of content 12. In addition, content interaction analysis system 108 may identify actors or individuals that user 110 understands based on the analysis. The actors and/or individuals may speak clearly or loudly so user 110 may select captioning off 19 while the actors and/or individuals are speaking.

Another use case may include content interaction analysis system 108 analyzing the context information 24 associated with time period 20. Content interaction analysis system 108 may analyze the time of day associated with time period 20. If user 110 consistently turns captioning on 15 in the evenings and has captioning off 19 during the daytime, content interaction analysis system 108 may learn that user 110 prefers to have captioning on in the evenings and prefers to have captioning off during the daytime.

Another use case may include content interaction analysis system 108 analyzing the content information 22 associated with time period 20. Content interaction analysis system 108 may analyze the genre of content 12 and the associated user input 14. If user 110 turns captioning on 15 for action movies, content interaction analysis system 108 may learn that user 110 likes to have captioning on for action movies. If user 110 turns captioning off 19 for comedies, content interaction analysis system 108 may learn that user 110 does not need captioning for comedies.

As such, content interaction analysis system 108 may correlate the user interactions associated with one or more identified factors that may trigger captioning to learn user habit information 28 for whether user 110 may need captioning or may not need captioning.

Content interaction analysis system 108 may build a data structure 30 for user 110 with the user habit information 28. The data structure 30 may include an aggregation of the user habit information 28 learned from all content 12 viewed by user 110. Content interaction analysis system 108 may use the data structure 30 of the user habit information 28 to generate one or more captioning recommendations 32 for user 110. Different types of content 12 may have different captioning recommendations 32 for user 110. Captioning recommendations 32 may include a binary recommendation (e.g., yes or no) for whether to turn captioning on or off for user 110. Captioning recommendations 32 may also include a score (e.g., 80%) indicating whether to turn captioning on or off for user 110.

Content interaction analysis system 108 may be a machine learning system that continuously learns user habit information 28 based on the information received from user device 102. The information received from user device 102, user input 14, time period 20, content information 22, context information 24, and/or any user habit information 28 may be used as input information to train a model of the machine learning system based on identified trends or patterns detected within the input information.

As additional information is received from user device 102 (e.g., new content information, new user inputs, new context information, and/or new or different time periods), content interaction analysis system 108 may use the additional information to train the machine learning system to update the user habit information 28 and make any modifications and/or changes to captioning recommendations 32.

For example, if captioning recommendation 32 provided a recommendation to turn on captioning when an individual was speaking French but user 110 provided user input 14 overriding the captioning on recommendation and selected captioning off 19 during the time period 20 that the individual was speaking French, content interaction analysis system 108 may use this new information to train the machine learning system to update the user habit information 28 for user 110 to indicate that the captioning recommendation 32 may be incorrect and that user 110 may not need captioning when individuals are speaking French. Content interaction analysis system 108 may access the newly updated user habit information 28 to use when making any future captioning recommendations 32 provided for user 110 with French speakers in content 12.

Content interaction analysis system 108 may continuously learn the user habit information 28 for user 110 for all content 12 viewed by user 110 and may continue to update data structure 30 and/or captioning recommendations 32 with any changes and/or additions. As such, content interaction analysis system 108 may be continuously working in the background while user 110 is consuming content. User habit information 28 for user 110 may be continuously gathered and analyzed by content interaction analysis system 108.

Content interaction analysis system 108 may provide content provider 106 the captioning recommendations 32 for content 12 and user 110. The captioning recommendations 32 may be used in deciding whether to turn captions on or turn captions off for content 12 when requested by user 110. Content interaction analysis system 108 may be triggered to send the captioning recommendations 32 in response to user 110 selecting smart captioning 23. In an implementation, smart captioning 23 may be a default user setting, and thus, content interaction analysis system 108 may send the captioning recommendations 32 to content provider 106. User 110 may turn off smart captioning 23 as the default user setting if user 110 does not prefer the smart captioning 23 setting. Content interaction analysis system 108 may also provide content provider 106 the data structure 30 for user 110. In an implementation, content interaction analysis system 108 may provide a plurality of content providers 106 the captioning recommendations 32 and/or the data structure 30 for user 110 may be used in deciding whether to turn captions on or turn captions off when user 110 requests content 12.

Content provider 106 may receive a content request 10 from user device 102 associated with user 110. Content provider 106 may receive user input 14 with a captioning request (e.g., captioning on 15, captioning off 19, or smart captioning 23). In addition, content provider 106 may also receive one or more captioning recommendations 32 for user 110.

Content provider 106 may use the captioning recommendations 32 and/or any received user input 14 to make a captioning decision 34 for content 12. In an implementation, content provider 106 may receive the data structure 30 for user 110 and may use the information in the data structure 30 to make a captioning decision 34 for content 12. The captioning decision 34 may include captions on 36 or captions off 38. In addition, the captioning decision 34 may optionally include a volume control request 26 to lower the volume of audio output of user device 102. Thus, the content provider 106 may make a captioning decision 34 to have captions on 36 and may also send a volume control request 26 to user device 102 to lower the volume of audio output when playing content 12.

Content provider 106 may use the captioning decision 34 to either turn on captions 18 with content 12 or turn off captions 18 with content 12. Caption 18 may include text of a transcript or translation of the dialogue, sound effects, relevant musical cues, and/or other relevant audio information occurring in content 12. Content provider 106 may dynamically update the captioning decision 34 for different time periods 20 of content 12 based on the captioning recommendations 32 and/or the received user input 14. Thus, the captions 18 may be turned on or turned off during different time periods 20 of content 12.

By dynamically turning captions on or turning captions off, the user experience with content 12 may be improved by having the captions turned on when user 110 may need captioning and turning the captions off when user 110 may not need captioning. Thus, by tailoring the captions to the habits and interactions of user 110, user 110 may receive the benefits of captioning when needed without having to specifically request captioning.

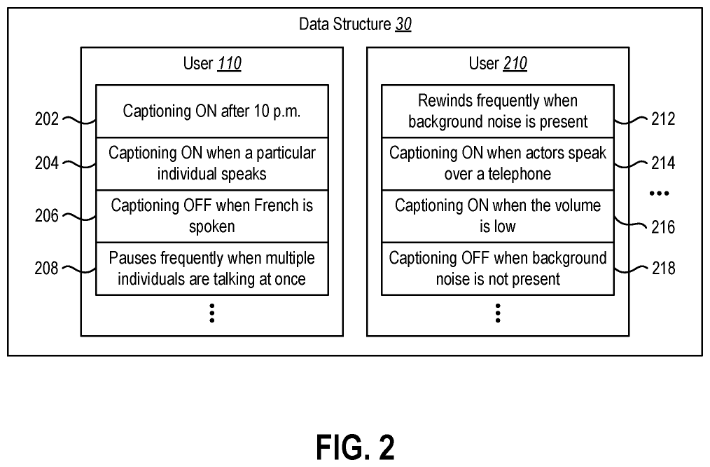

Referring now to FIG. 2, illustrated is an example schematic diagram of a data structure 30 for use with environment 100 (FIG. 1). Data structure 30 may include a plurality of rows for each user 110, 210 with user habit information 28 (FIG. 1) learned by content interaction analysis system 108 (FIG. 1) for one or more users 110, 210. For example, row 202, may identify that user 110 turns captioning on after 10:00 p.m. Row 204 may identify that user 110 turns captioning on when a particular individual speaks. Row 206 may identify that user 110 turns captioning off when French is spoken. Row 208 may identify that user 110 pauses frequently when multiple individuals are talking at once. Row 212 may indicate that user 210 rewinds frequently when background noise is present. Row 214 may indicate that user 210 turns captioning on when actors speak over a telephone. Row 216 may indicate that user 210 turns captioning on when the volume is low. Row 218 may indicate that user 210 turns captioning off when background noise is not present.

Data structure 30 may include an aggregation of user habit information 28 learned by content interaction analysis system 108 (FIG. 1) for each user 110, 210 of environment 100 for all content viewed by users 110, 210. Data structure 30 may be continuously updated with new user habit information 28 learned by content interaction analysis system 108. Thus, as more user habit information 28 is learned by content interaction analysis system 108 for users 110, 210, more rows may be added to data structure 30 for users 110, 210. In addition, as more users use environment 100, more users and the corresponding user habit information 28 may be added to data structure 30.

Content interaction analysis system 108 may use data structure 30 in making captioning recommendations 32 (FIG. 1) for users 110, 210. In addition, content provider 106 may use data structure 30 in making captioning decisions 34 for users 110, 210.

In an implementation, data structure 30 may be standardized so that data structure 30 is in a standard form for all users 110, 210. By standardizing data structure 30 more than one content provider 106 may use and understand the user habit information 28 contained within data structure 30 to make captioning decisions 34.

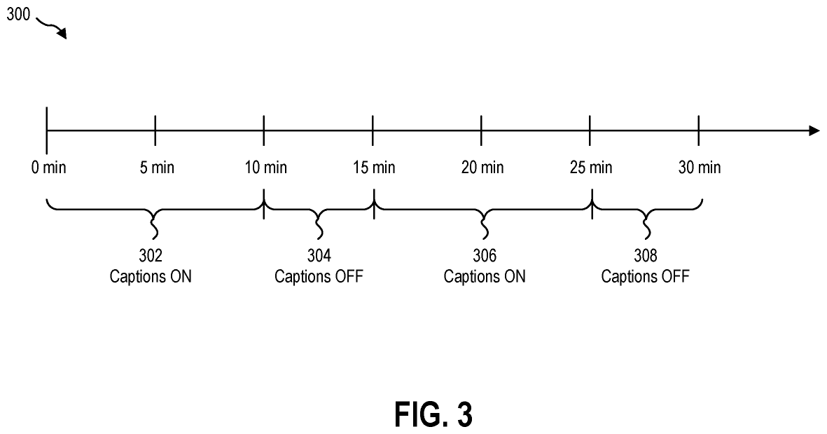

Referring now to FIG. 3, illustrated is an example timeline 300 of content 12 (FIG. 1) using smart captioning 23 (FIG. 1). FIG. 3 may be discussed below with reference to the architecture of FIG. 1. For example, content provider 106 may receive a captioning recommendation 32 to turn captioning on for a first time period 302 (e.g., the first 10 minutes of content 12). Content provider 106 may use the captioning recommendation 32 to make a captioning decision 34 to turn captions on 36 for the first time period 302. As such, display 16 of user device 102 may present captions 18 for content 12 during the first 10 minutes of content 12.

Content provider 106 may receive a captioning recommendation 32 to turn captioning off for a second time period 304 (e.g., from 10 minutes to 15 minutes). Content provider 106 may use the captioning recommendation 32 to make a captioning decision 34 to turn captions off 38 for the second time period 304 and display 16 may remove captions 18 for content 12 during the next five minutes.

Content provider 106 may receive a captioning recommendation 32 to turn captioning on for a third time period 306 (e.g., from 15 minutes to 25 minutes). Content provider 106 may use the captioning recommendation 32 to make a captioning decision 34 to turn captions on 36 for the third time period 306 and display 16 may present captions 18 for content 12 during the third time period 306.

Content provider 106 may receive a captioning recommendation 32 to turn captioning off for a fourth time period 308 (e.g., from 25 minutes to 30 minutes). Content provider 106 may use the captioning recommendation 32 to make a captioning decision 34 to turn captions off 38 for the fourth time period 308 and display 16 may remove captions 18 for content 12 during the fourth time period 308.

As such, the captions 18 may be dynamically updated from turning on to turning off during different time periods 302, 304, 306, 308 of content 12.

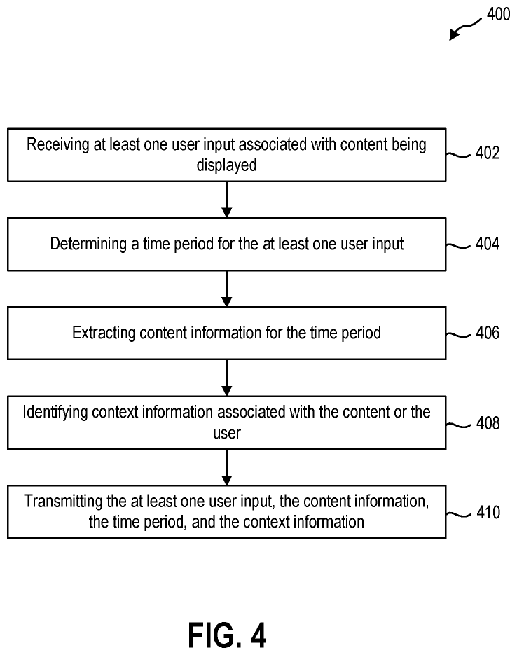

Referring now to FIG. 4, an example method 400 may be used by user device 102 (FIG. 1) for transmitting user information to content interaction analysis system 108 (FIG. 1). The actions of method 400 may be discussed below with reference to the architecture of FIG. 1.

At 402, method 400 may include receiving at least one user input associated with content being displayed. User device 102 may receive user input 14 indicating a captioning preference for user 110. For example, user 110 may select captioning on 15 (e.g., displaying captions 18 with content 12), captioning off 19 (stopping or otherwise removing captions 18 from displaying with content 12), or smart captioning 23. Smart captioning 23 may dynamically update displaying captions 18 with content 12 and may turn off captions 18 from displaying with content 12 based on the content 12 and/or user 110. Thus, instead of user 110 specifying whether to turn captioning on 15 or turn captioning off 19, smart captioning 23 may automatically turn captioning on or turn the captioning off based on learned user habits information associated with captioning. In addition, user device 102 may receive one or more user inputs 14 to control a display of content 12. For example, user 110 may pause 17 content 12, stop 21 content 12, and/or rewind 25 content 12.

At 404, method 400 may include determining a time period for the at least one user input. User device 102 may determine a time period 20 associated with the one or more user inputs 14. Time period 20 may start upon user device 102 receiving user input 14 and may end upon completion of an action associated with user input 14 and/or user device 102 receiving a different user input 14. For example, time period 20 may identify an amount of time a user rewound content 12 or paused content 12. Another example of time period 20 may include an amount of time user 110 selected captioning on 15. Yet another example of time period 20 may include an amount of time user 110 selected captioning off 19.

At 406, method 400 may include extracting content information for the time period. User device 102 may automatically extract content information 22 from content 12 associated with time period 20. Content information 22 may include, but is not limited to, a genre (e.g., comedy, action, or crime), a content type (e.g., movie, television show, documentary), volume of the audio output by user device 102, identifying actors present during time period 20, languages spoken during time period 20, and/or any other information that may be extracted from content 12 by user device 102. For example, if user device 102 identified that the user selected captioning on 15 for ten minutes while content 12 played, user device 102 may extract the volume of the audio output by user device 102 during the ten minutes that the captioning was on as the content information 22.

At 408, method 400 may include identifying context information associated with the content of the user. User device 102 may identify any context information 24 associated with user 110 during time period 20. Context information may include, but is not limited to, date information, time information (e.g., nighttime, early morning, middle of the day), geographic location information (e.g., moving vehicle, home, or work), environment information (e.g., inside, outside, or current weather), and/or any additional information that may describe an environment of user 110. For example, if user device 102 identified that the user selected captioning off 19 at lunchtime, user device 102 may identify the time of day (e.g., noon) as the context information 24 when user 110 selected captioning off 19.

At 410, method 400 may include transmitting the at least one user input, the content information, the time period, and the context information. User device 102 may automatically transmit user input 14, time period 20, content information 22, and/or any context information 24 to content interaction analysis system 108. In an implementation, user device 102 may periodically transmit the user inputs 14, time periods 20, content information 22, and/or any context information 24 to content interaction analysis system 108. As such, user device 102 may aggregate the user inputs 14, time periods 20, content information 22, and/or any context information 24 and may transmit the information at set time periods (e.g., every 10 minutes).

In another implementation, user device 102 may transmit user input 14, time period 20, content information 22, and/or any context information 24 to content interaction analysis system 108 in response to one or more triggering events. Triggering events may include, but are not limited to, content 12 ending or stopping, user 110 selecting captioning on 15, user 110 selecting captioning off 19, user 110 selecting smart captioning 23, user 110 selecting to pause the content 12, user 110 selecting to stop 21 the content 12, user 110 selecting to rewind 25 the content 12, and/or user 110 providing a volume control 27 (e.g., mute, lowering the volume, or raising the volume).

Method 400 may repeat as user 110 selects different or new content to view. In addition, method 400 may repeat as the time periods change for content 12. Thus, user device 102 may continue to identify new user interaction information associated with content 12, new context information 24, and/or new content information 24 to transmit to content interaction analysis system 108.

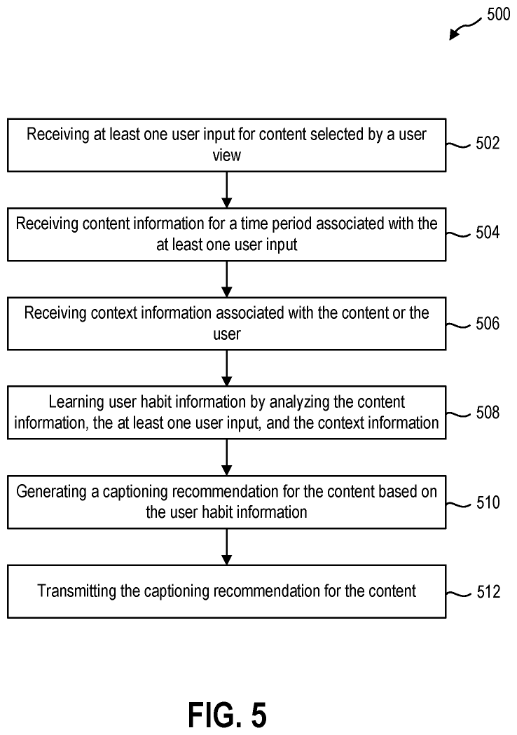

Referring now to FIG. 5, an example method 500 may be used by content interaction analysis system 108 (FIG. 1) for generating a captioning recommendation. The actions of method 500 may be discussed below with reference to the architecture of FIG. 1.

At 502, method 500 may include receiving at least one user input for content selected by a user to view. Content interaction analysis system 108 may receive user input 14 from one or more user devices 102. User input 14 may include, but is not limited to, selecting captioning on 15, selecting captioning off 19, selecting smart captioning 23, pausing 17 content 12, stopping 21 content 12, and/or rewinding 25 content 12. User 110 may preform one or more user inputs 14 during different time periods 20 for content 12. For example, user 110 may turn captioning off 19 during the first fifteen minutes of content 12 and may also rewind 25 content 12 during the first fifteen minutes of content 12. In addition, user 110 may turn captioning on 15 during the last ten minutes of content 12. Thus, content interaction analysis system 108 may receive all user input 14 associated with content 12.

At 504, method 500 may include receiving content information for a time period associated with the at least one user input. Content interaction analysis system 108 may receive content information 22 for different time periods 20 associated with different user inputs 14. Content information 22 may include, but is not limited to, a genre (e.g., comedy, action, or crime), a content type (e.g., movie, television show, documentary), volume of the audio output by user device 102, identifying actors present during time period 20, languages spoken during time period 20, and/or any other information that may be extracted from content 12 by user device 102. For example, content interaction analysis system 108 may receive information about the languages spoken during time period 20 for the content information 22.

At 506, method 500 may receive context information associated with the content or the user. Content interaction analysis system 108 may receive context information 24 for different time periods 20 associated with different user inputs 14. Context information may include, but is not limited to, date information, time information (e.g., nighttime, early morning, middle of the day), geographic location information (e.g., moving vehicle, home, or work), environment information (e.g., inside, outside, or current weather), and/or any additional information that may describe an environment of user 110. For example, content interaction analysis system 108 may receive context information 24 indicating that user 110 is traveling on a train while watching content 12 during the time periods 20.

At 508, method 500 may include learning user habit information by analyzing the content information, the at least one user input, and the context information. Content interaction analysis system 108 may analyze the received information to learn user habit information 28 for user 110 and/or any captioning needs for user 110. Content interaction analysis system 108 may use the time period 20 to identify one or more factors in content 12, content information 22, and/or context information 24 that may have triggered a need for request for captioning. One or more factors may include, but are not limited to, a high signal to noise ratio in content 12, individuals speaking a foreign language in content 12, a time of day (e.g., nighttime), a volume level of user device 102 (e.g., a low volume or mute), individuals speaking foul language in content 12, a particular actor or individual speaking in content 12, rewinding content 12, pausing content 12, and/or stopping content 12.

Content interaction analysis system 108 may correlate, or otherwise associate, interactions user 110 took relative to the one or more potential factors that may trigger a need for captioning. Content interaction analysis system 108 may use this correlation or association to learn user habit information 28 for user 110 for whether user 110 may need captioning or may not need captioning.

Content interaction analysis system 108 may be a machine learning system that continuously learns user habit information 28 based on the information received from user device 102. The information received from user device 102, user input 14, time period 20, content information 22, context information 24, and/or any user habit information 28 may be used as input information to train a model of the machine learning system based on identified trends or patterns detected within the input information.

As additional information is received from user device 102, content interaction analysis system 108 may use the additional information to train the machine learning system to update the user habit information 28 and make any modifications and/or changes to captioning recommendations 32. As such, content interaction analysis system 108 may continuously learn the user habit information 28 for user 110 for all content 12 viewed by user 110 and may continue to update data structure 30 and/or captioning recommendations 32 with any changes and/or additions.

At 510, method 500 may include generating a captioning recommendation for the content based on the user habit information. Content interaction analysis system 108 may use the user habit information 28 to generate one or more captioning recommendations 32 for user 110. Captioning recommendations 32 may include a binary recommendation (e.g., yes or no) for whether to turn captioning on or off for user 110. Captioning recommendations 32 may also include a score (e.g., 80%) indicating whether to turn captioning on or off for user 110.

At 512, method 500 may include transmitting the captioning recommendation for the content. Content interaction analysis system 108 may provide content provider 106 the captioning recommendations 32 for content 12 and user 110 for use in deciding whether to turn captions on or turn captions off for content 12 when requested by user 110. In an implementation, content interaction analysis system 108 may be triggered to send the captioning recommendations 32 in response to user 110 selecting smart captioning 23. In addition, content interaction analysis system 108 may provide content provider 106 the data structure 30 for user 110. In an implementation, content interaction analysis system 108 may provide a plurality of content providers 106 the captioning recommendations 32 and/or the data structure 30 for user 110 may be used in deciding whether to turn captions on or turn captions off when user 110 requests content 12.

By continuously learning the habits of the users, method 500 may be used to tailor the captioning for the user based on the user habit information 28. The user experience with content may be improved by having the captions turned on when the user may need captioning and turning the captions off when the user may not need captioning.

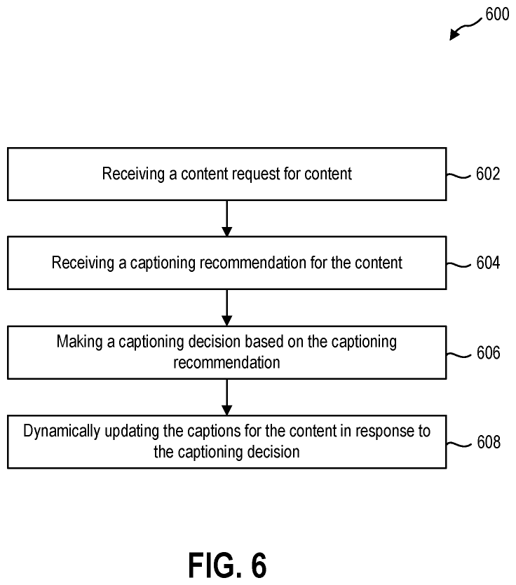

Referring now to FIG. 6, an example method 600 may be used by content provider 106 (FIG. 1) for dynamically updating captions. The actions of method 600 may be discussed below with reference to the architecture of FIG. 1.

At 602, method 600 may include receiving a content request for content. Content provider 106 may receive a content request 10 from user device 102 associated with user 110. Content providers 106 may host a plurality of content 12 and may receive the content request 10 for content 12. Content provider 106 may provide the requested content 12 to user device 102. For example, content provider 106 may transmit content 12 to user device 102. In addition, content provider 106 may provide direct access to the content 12 by user device 102 (e.g., streaming content 12 directly by user device 102).

At 604, method 600 may include receiving a captioning recommendation for the content. Content provider 106 may also receive one or more captioning recommendations 32 for user 110. Captioning recommendations 32 may provide a suggestion or recommendation for turning captioning on or turning captioning off for user 110 based on the content 12 and/or the user habit information 28 for user 110.

At 606, method 600 may include making a captioning decision based on the captioning recommendation. Content provider 106 may use the captioning recommendations 32 and/or any received user input 14 to make a captioning decision 34 for content 12. The captioning decision 34 may include captions on 36 or captions off 38. In addition, the captioning decision 34 may optionally include a volume control request 26 to lower the volume of audio output of user device 102.

At 608, method 600 may include dynamically updating the captions for the content in response to the captioning decision. Content provider 106 may use the captioning decision 34 to either turn on captions 18 with content 12 or turn off captions 18 with content 12. Caption 18 may include text of a transcript or translation of the dialogue, sound effects, relevant musical cues, and/or other relevant audio information occurring in content 12.

Content provider 106 may dynamically update the captioning decision 34 for different time periods 20 of content 12 based on the captioning recommendations 32 and/or the received user input 14. As such, the captions 18 may be dynamically turned on or turned off during different time periods 20 of content 12.

Method 600 may improve the user experience with content 12 by dynamically turning captions on or turning captions off. The captions may be turned on when user 110 may need captioning and the captions may be turned off when user 110 may not need captioning. Thus, method 600 may be used to tailor the captions to the user 110 and user 110 may receive the benefits of captioning when needed without having to specifically request captioning.

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, embodiments of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
receiving at least one user input for content selected by the user to view on a user device;
receiving content information for a time period associated with the at least one user input;
receiving context information associated with the content or the user, wherein the context information describes an environment of the user when viewing the content;
learning user habit information by analyzing the content information, the at least one user input, and the context information to identify a plurality of factors in the time period that triggered a request for captioning and correlating interactions the user took relative to the plurality of factors to determine the user habit information for the time period, wherein the plurality of factors include a signal to noise ratio in the content or a time of day;
generating a captioning recommendation for the content based on the user habit information; and
transmitting the captioning recommendation for the content.

2. The method of claim 1, further comprising:
continuously learning the user habit information by analyzing new user input received for a different time period, new content information received for the different time period, and new context information received;
updating the captioning recommendation based on the user habit information; and
transmitting the updated captioning recommendation.

3. The method of claim 2, further comprising:
building a data structure with an aggregation of the user habit information for the different time period, wherein the data structure is in a standard form; and
transmitting the data structure.

4. (canceled)

5. The method of claim 1, wherein the at least one user input includes turning captioning on, turning captioning off, rewinding the content, pausing the content, stopping the content, muting a volume associated with the content, or lowering a volume associated with the content.

6. The method of claim 1, wherein the content information includes one or more of a content type, a genre of the content, a volume of audio output, individuals speaking during the time period, and a language spoken during the time period.

7. The method of claim 1, further comprising:
continuously learning the user habit information by analyzing new user input received for different content, new content information received for the different content, and new context information associated with the different content or the user;
updating the captioning recommendation based on the user habit information; and
transmitting the updated captioning recommendation.

8. A computer device, comprising:
a memory to store data and instructions; and
at least one processor operable to communicate with the memory, wherein the at least one processor is operable to:
receive at least one user input for content selected by the user to view on a user device;
receive content information for a time period associated with the at least one user input;
receive context information associated with the content or the user, wherein the context information describes an environment of the user when viewing the content;
learn user habit information by analyzing the content information, the at least one user input, and the context information to identify a plurality of factors in the time period that triggered a request for captioning and correlating interactions the user took relative to the plurality of factors to determine the user habit information for the time period, wherein the plurality of factors include a signal to noise ratio in the content or a time of day;
generate a captioning recommendation based on the user habit information; and
transmit the captioning recommendation for the content.

9. The computer device of claim 8, wherein the at least one processor is further operable to:
continuously learn the user habit information by analyzing new user input received for a different time period, new content information received for the different time period, and new context information received;
update the captioning recommendation based on the user habit information; and
transmit the updated captioning recommendation.

10. The computer device of claim 9, wherein the at least one processor is further operable to:
build a data structure with an aggregation of the user habit information for the different time period.

11. The computer device of claim 10, wherein the data structure is in a standard form.

12. The computer device of claim 8, wherein the at least one user input includes turning captioning on, turning the captioning off, rewinding the content, pausing the content, stopping the content, muting a volume associated with the content, or lowering a volume associated with the content.

13. The computer device of claim 8, wherein the content information includes one or more of a content type, a genre of the content, a volume of audio output, individuals speaking during the time period, and a language spoken during the time period.

14. The computer device of claim 8, wherein the at least one processor is further operable to:
continuously learn the user habit information by analyzing new user input received for different content, new content information received for the different content, and new context information associated with the different content or the user;
update the captioning recommendation based on the user habit information; and
transmit the updated captioning recommendation.

15. A method, comprising:
receiving a content request for content;
receiving a captioning recommendation for turning on captioning or turning off captioning for the content in response to a user selecting smart captioning, wherein the captioning recommendation is based on learned user habit information to identify a plurality of factors that triggered a request for captioning and correlating interactions the user took relative to the plurality of factors to determine the user habit information and wherein the plurality of factors include a signal to noise ratio in the content or a time of day;
making a captioning decision to turn captions on or turn the captions off for the content based on the captioning recommendation; and
dynamically updating the captions for the content in response to the captioning decision.

16. The method of claim 15, wherein the captioning recommendation is associated with a user.

17. The method of claim 15, wherein the captioning recommendation is a binary recommendation or a score.

18. The method of claim 15, wherein dynamically updating the captioning further includes:
turning the captioning on for a time period; and
turning the captioning off after the time period.

19. The method of claim 15, further comprising:
sending a volume control request to a user device displaying the content to lower the volume for audio of the content; and
wherein dynamically updating the captioning further includes turning the captioning on when sending the volume control request to lower the volume.

20. The method of claim 15, further comprising:
receiving user input with a captioning selection; and
wherein making the captioning decision further includes turning the captioning on or turning the captioning off in response to the captioning selection.

21. The method of claim 1, wherein the plurality of factors includes two or more of foul language in the content, a particular individual speaking in the content, rewinding content, pausing content, or stopping content, and
wherein the environment of the user includes one or more of geographic location information of the user, whether the user is outside, whether the user is travelling in a moving vehicle, or date information.
